(19) United States
(12) Patent Application Publication
(10) Pub. No.: US 2006/0248457 A1
(43) Pub. Date: Nov. 2, 2006

(54) Input device

(75) Inventors: Yoshihiko Yamamoto, Fukushima-ken (JP); Yasuji Hagiwara, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/406,704

(22) Filed: Apr. 19, 2006

(30) Foreign Application Priority Data
Apr. 22, 2005 (JP) 2005-124578

(51) Int. Cl. G06F 17/00

(52) U.S. Cl. 715/535

(57) ABSTRACT

To read and display the hiragana character “e” on a display device, an operator traces the outline of an input button three times with a finger. This allows a character on the display device to be changed sequentially from “a” to “i”→“u”→“e”.

### BACKGROUND OF THE INVENTION

1. Field of the Invention

The present invention relates to an input device that allows users to easily enter characters with simpler operation than before.

2. Description of the Related Art

Mobile phones provide a variety of communication modes, such as email mode and Web mode, as well as phone mode. By pressing a plurality of input buttons on a control panel of a mobile phone, the user can enter numbers in phone mode and can enter hiragana characters and the like in email mode (NOTE: Hiragana characters represent sounds in the Japanese writing system and are typically used for words native to Japan). For example, hiragana characters in each column in the Japanese syllabary are stored in correspondence with each input button, and one of the input buttons allows the entry of hiragana characters in the “a”-column (which is the first column in the Japanese syllabary and contains five hiragana characters in the following order: “a”, “i”, “u”, “e”, and “o”). Generally, if the user wishes to enter the hiragana character “u”, the user presses this input button three times to allow the hiragana characters “a”, “i”, and “u” to be sequentially displayed on the display panel, thereby entering the hiragana character “u”.

This input method involves the pressing of an input button to allow a desired character to be displayed on the display panel. Therefore, the increased number of characters to be entered means the increased number of button presses and thus causes fatigue on fingers. Moreover, in this input method, a plurality of characters assigned to each input button are displayed according to a certain readout sequence and in a cyclic manner. Specifically, if the input button is pressed while the hiragana character “o” (the fifth character in the “a”-column) is displayed, the hiragana character “a” (the first character in the “a”-column) is displayed on the display panel again. In this cyclic display method, if the user presses the input button an excessive number of times and the hiragana character “u” (the third character in the “a”-column) instead of a desired hiragana character “i” (the second character in the “a”-column) is displayed on the display panel, the user has to allow the hiragana characters “e”→“o”→“a” (the fourth, fifth, and first characters in the “a”-column) to be displayed on the display panel to allow the hiragana character “i” to be displayed again. In other words, once the display of a desired character is past, the user has to go though a cumbersome process of displaying other characters in a cyclic manner, so as to display the desired character again. The only alternative to this method is to delete the displayed character and start entering the character again.

Japanese Unexamined Patent Application Publication No. 2001-274888 and Japanese Unexamined Patent Application Publication No. 8-202520 disclose input methods different from that described above.

Japanese Unexamined Patent Application Publication No. 2001-274888 discloses an input method in which pressing one of ten keys corresponding to the numbers from 0 to 9 allows all characters contained in a first character group stored in correspondence with the pressed key to be displayed on a display panel (see FIG. 6 in Japanese Unexamined Patent Application Publication No. 2001-274888). The arrangement of the displayed characters in the first character group corresponds to the key arrangement. Therefore, pressing a key corresponding to the display position of a desired character allows the character to be entered (or confirmed).

However, in this input method disclosed in Japanese Unexamined Patent Application Publication No. 2001-274888, the user has to locate the desired character from the first character group after all the characters in the first character group are displayed on the display panel. In this case, as the number of characters contained in the first character group increases, it takes longer to locate the desired character. Moreover, since the user has to press a key corresponding to the position of the desired character, an appropriate key needs to be selected from a plurality of keys to enter the desired character. This involves a very cumbersome process and does not allow quick entry of characters.

Japanese Unexamined Patent Application Publication No. 8-202520 discloses an input method for entering Japanese characters using Roman characters. To enter characters, the user allows consonant signs or vowel signs in each of a first input information group, a second input information group, and a third input information group (see FIG. 2 in Japanese Unexamined Patent Application Publication No. 8-202520) to be displayed, in this order, on concentric circles on a display panel, and selects the displayed consonant signs and vowel signs with a cursor. For example, to enter “kyo” in Japanese characters (see FIG. 1 in Japanese Unexamined Patent Application Publication No. 8-202520), the user first selects the consonant “K” from the first input information group, then selects “y” from the second input information group, and then selects “o” from the third input information group.

However, the input method disclosed in Japanese Unexamined Patent Application Publication No. 8-202520 involves a very cumbersome process of selecting necessary consonants and vowels with a cursor from the input information groups displayed on the mobile phone's display, which is not very large. Moreover, this input method involves a process of locating necessary consonants and vowels from the displayed input information groups and thus does not allow quick entry of characters.

### SUMMARY OF THE INVENTION

The present invention has been made in view of the problems described above and specifically aims to provide an input device that allows users to easily enter characters with simpler operation than before.

In an aspect of the present invention, an input device having a control panel provided with a plurality of input buttons, wherein a plurality of characters having a predetermined readout sequence are stored in correspondence with each of the input buttons, and wherein using an operating member on the control panel allows a character to be entered, includes a first readout means configured to allow the first character in the readout sequence to be read by performing a first operation on one of the input buttons; a second readout means configured to allow a read character to be changed according to the readout sequence by performing a second operation of sliding the operating member over the control panel; and an input means configured to allow the input of a desired character to be confirmed by performing a third operation when the desired character has been read.

In particular, since the input device of the present invention includes the second readout means configured to allow a read character to be changed according to the readout sequence by performing the second operation of sliding the operating member over the control panel, characters can be entered by a simpler and easier operation than before.

In another aspect of the present invention, the first operation is, for example, to bring the operating member into contact with a surface of the input button. This is preferable, as the first character in the readout sequence can be easily read.

In another aspect of the present invention, the second operation is, for example, to slide the operating member along the outline of the input button or over a surface of the input button. More specifically, the character can be changed according to the readout sequence by moving the operating member a predetermined distance at a time along the outline of the input button.

In another aspect of the present invention, the third operation is to release the operating member from the control panel or to press a specific input button.

In the present invention, after the first character in the readout sequence is read by the first operation performed on an input button, characters are sequentially read in response to the second operation in which the operating member (e.g., finger) slides over the control panel.

A simpler and easier entry of characters than before can thus be achieved.

### BRIEF DESCRIPTION OF THE DRAWINGS

FIG. 1 is a partial front view of a mobile phone including an input device of the present invention.

FIG. 2 is a partial cross-sectional view taken along line II-II of the mobile phone in FIG. 1 as viewed from the direction indicated by arrows.

FIG. 3A is a partial front view of a control panel of a mobile phone for illustrating a first operation for entering characters according to the present invention. FIG. 3B is an exemplary display screen appearing in response to the first operation.

FIG. 4A is an enlarged partial front view of a control panel of a mobile phone for illustrating a second operation for entering characters according to the present invention. FIG. 4B is an exemplary display screen appearing in response to the second operation.

FIG. 5 is an enlarged partial front view of a control panel of a mobile phone for illustrating a modified second operation different from the second operation illustrated in FIG. 4A.

FIG. 6 is a partial front view of a control panel of a mobile phone for illustrating another modified second operation different from the operations illustrated in FIG. 4A and FIG. 5.

FIG. 7 is a flowchart showing the process of entering characters.

FIG. 8 is a block diagram illustrating the entire configuration of a mobile phone including the input device of the present invention.

### DESCRIPTION OF THE PREFERRED EMBODIMENTS

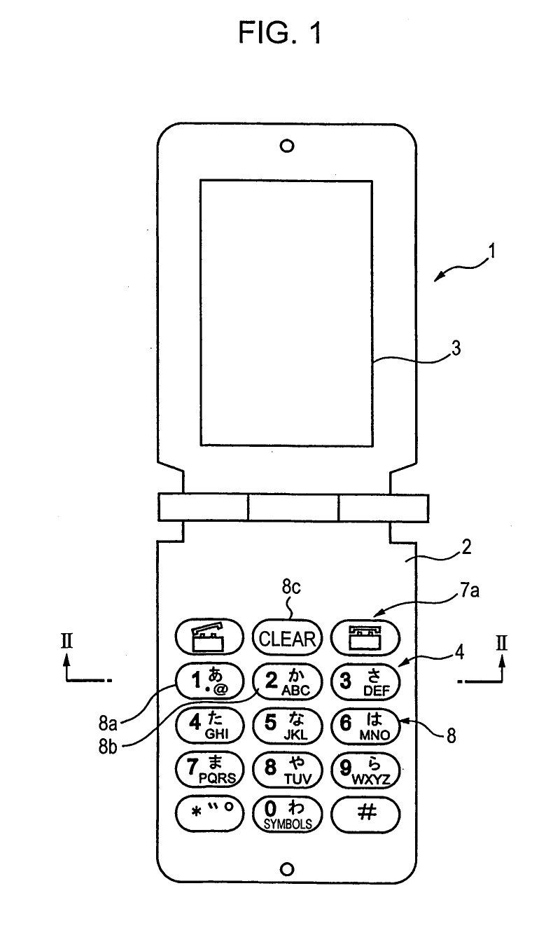

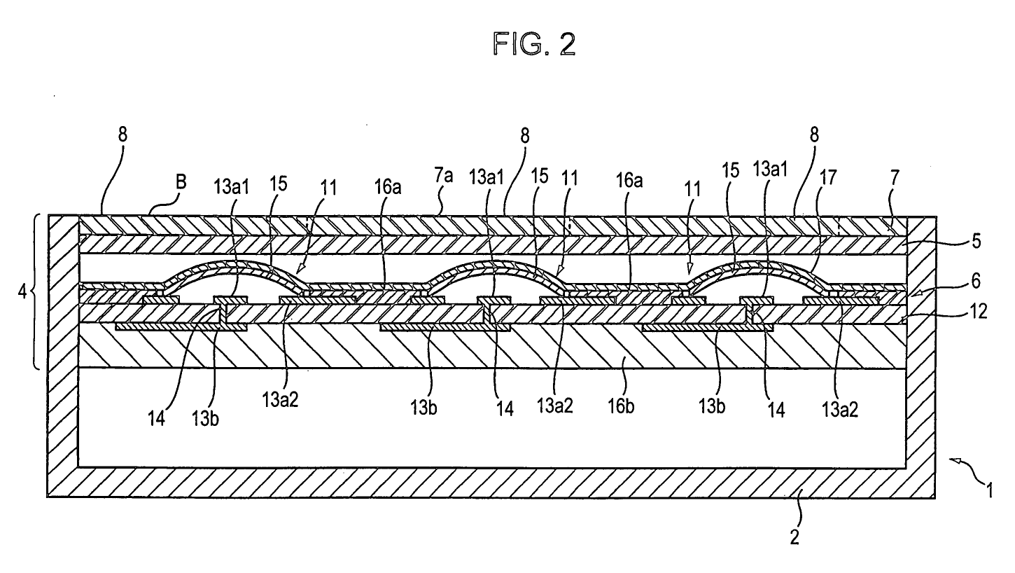

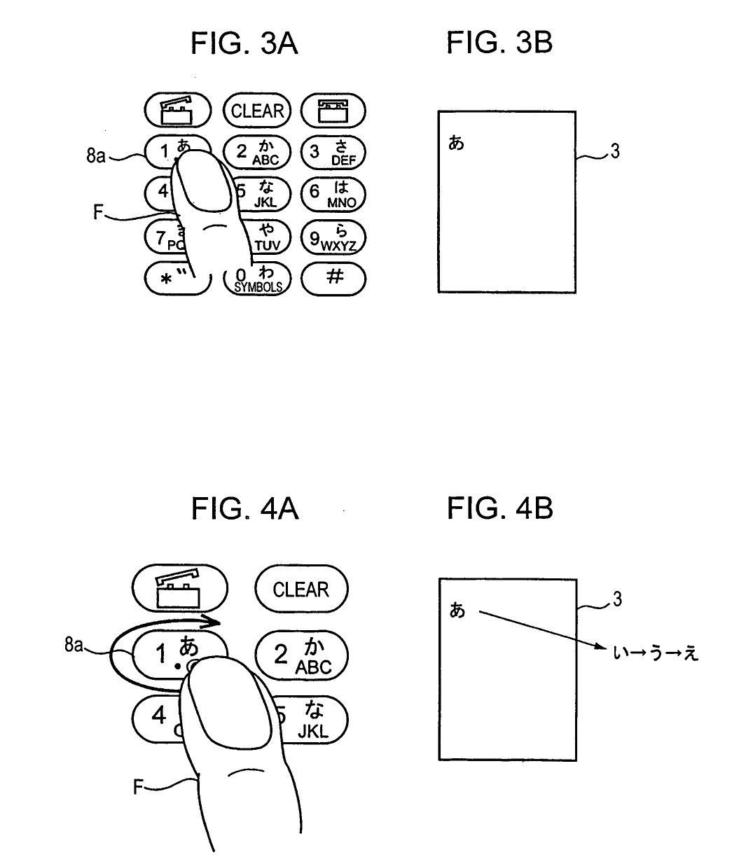

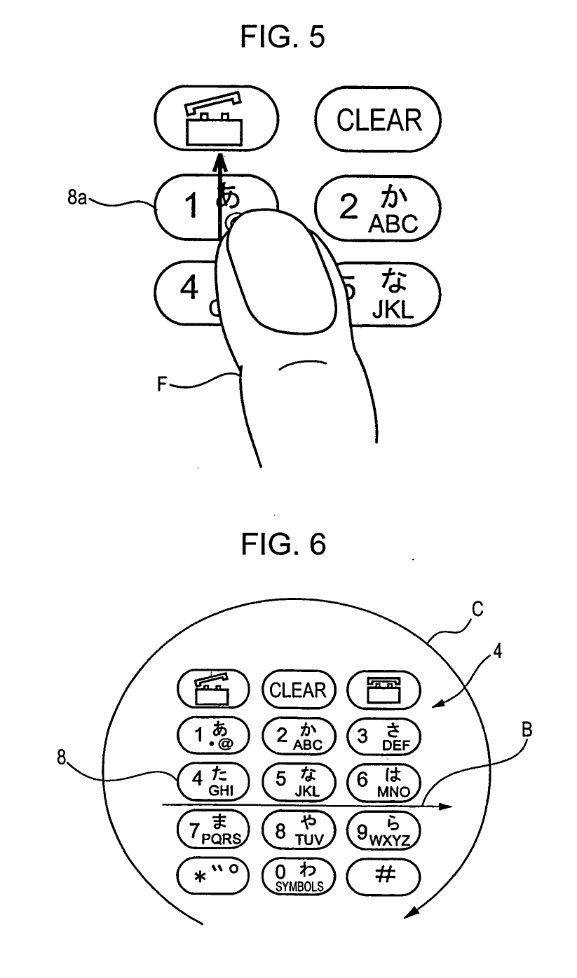

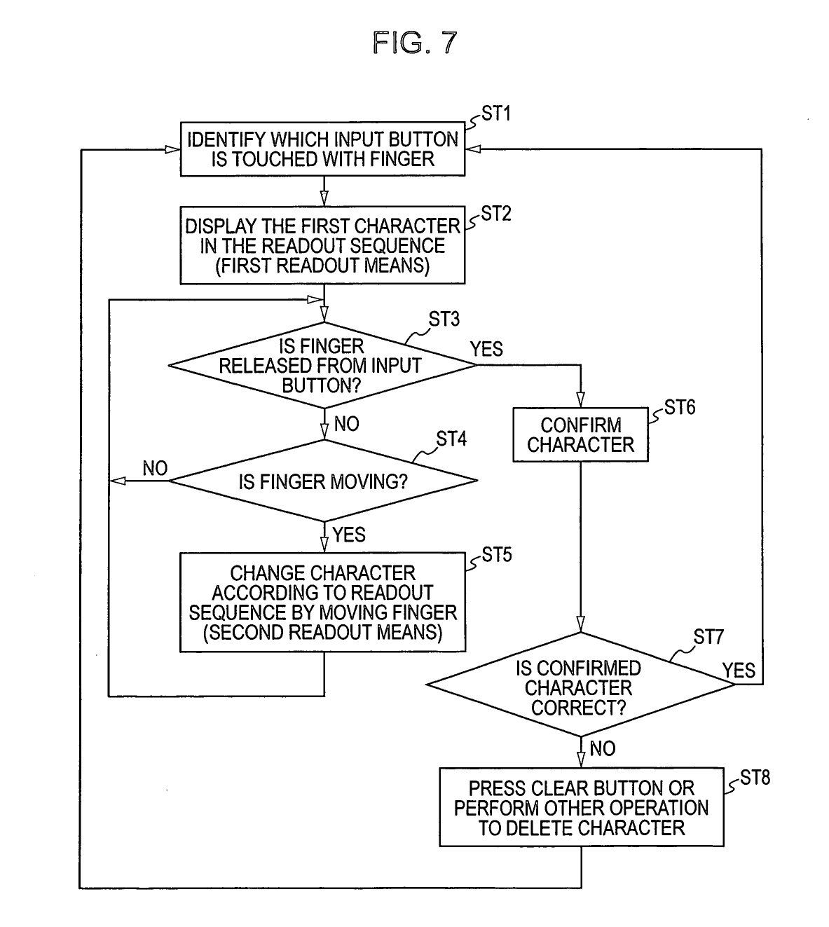

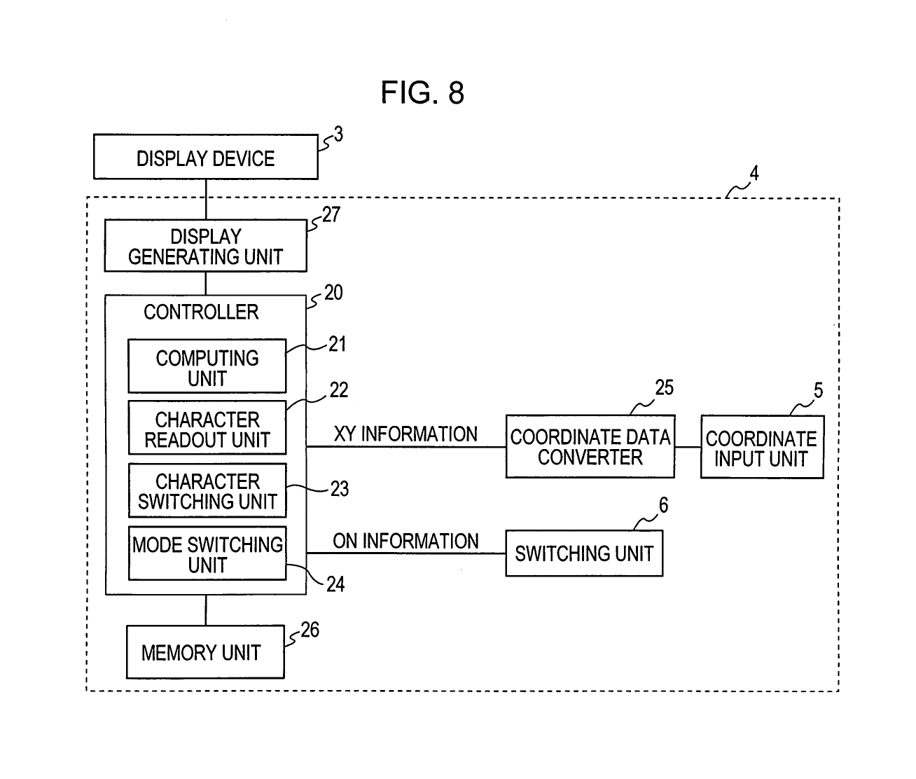

FIG. 1 is a partial front view of a mobile phone including an input device of the present invention. FIG. 2 is a partial cross-sectional view taken along line II-II of the mobile phone in FIG. 1 as viewed from the direction indicated by arrows. FIG. 3A is a partial front view of a control panel of a mobile phone for illustrating a first operation for entering characters according to the present invention. FIG. 3B is an exemplary display screen appearing in response to the first operation. FIG. 4A is an enlarged partial front view of a control panel of a mobile phone for illustrating a second operation for entering characters according to the present invention. FIG. 4B is an exemplary display screen appearing in response to the second operation. FIG. 5 is an enlarged partial front view of a control panel of a mobile phone for illustrating a modified second operation different from the second operation illustrated in FIG. 4A. FIG. 6 is a partial front view of a control panel of a mobile phone for illustrating another modified second operation different from the operations illustrated in FIG. 4A and FIG. 5. FIG. 7 is a flowchart showing the process of entering characters. FIG. 8 is a block diagram illustrating the entire configuration of a mobile phone including the input device of the present invention.

Referring to FIG. 1, a mobile phone 1 includes a case (housing) 2 provided with a display device 3 serving as a display means and an input device 4. The display device 3 is a monochrome or color liquid crystal panel or an electroluminescence (EL) panel.

As illustrated in FIG. 2, the input device 4 includes a coordinate input unit 5, which is a capacitance-type device or pressure-sensitive device capable of inputting coordinates. The capacitance-type coordinate input unit includes X-direction electrodes and Y-direction sensing electrodes made of silver (Ag) paste and facing each other in a matrix form, with a resin sheet interposed therebetween. The resin sheet is made of, for example, polyethylene terephthalate (PET) having insulation properties and a predetermined dielectric constant. Touching a surface of the coordinate input unit 5 with a dielectric member, such as a finger (operating member), allows coordinates to be input.

On the other hand, the pressure-sensitive coordinate input unit includes a resistor with a potential difference in the X and Y directions and an electric conductor facing the resistor. Pressing the pressure-sensitive coordinate input unit with a finger or the like brings the electric conductor and the resistor into contact with each other, changes the resistance value, thereby allowing coordinates to be input.

Still referring to FIG. 2, in the input device 4, a surfacing sheet 7 is laminated and fixed to the surface of the coordinate input unit 5.

The surfacing sheet 7 is made of resin, such as PET, or silicon rubber. A control panel 7a on the surface of the surfacing sheet 7 provides a plurality of input buttons 8 formed by the process of printing or transfer printing and indicating the input positions of numbers, alphabetical characters, and symbols. Each input button 8 has a circular frame indicating the input position and is provided with characters, including a hiragana character, a numerical character, alphabetical characters, and symbols printed or transferred inside the frame.

The surfacing sheet 7 may have an embossed surface with raised portions corresponding to the input buttons 8. Alternatively, a surface of the surfacing sheet 7 may be provided with raised rubber dots (not shown), each marked with characters printed thereon or transferred thereto.

As illustrated in FIG. 2, a switching unit 6 is disposed under the coordinate input unit 5. The switching unit 6 includes the same number of switching parts 11 as the number of the input buttons 8. Electrodes (including circular electrodes 13a1 and annular electrodes 13a2) made of Ag paste and serving as electric conductors, and conductive patterns 13b are patterned by printing or the like on both sides of a resin sheet 12 made of PET to form the switching parts 11.

The upper surface of the resin sheet 12 is provided with the circular electrodes 13a1 and the annular electrodes 13a2 surrounding the corresponding circular electrodes 13a1 and arranged at predetermined intervals. The lower surface of the resin sheet 12 is provided with conductive patterns 13b connected to their corresponding circular electrodes 13a1. In other words, the resin sheet 12 under the circular electrodes 13a1 has through-holes each provided with a connecting conductor 14 for allowing continuity between a conductive pattern 13b and a circular electrode 13a1. Moreover, each annular electrode 13a2 is covered with a dome-shaped (diaphragm-like) reverse plate 15. The reverse plate 15 is arranged such that the top of the reverse plate 15 is aligned with its corresponding circular electrode 13a1 while the outer edge of the reverse plate 15 is in contact with its corresponding annular electrode 13a2.

A resist film 16a is provided around each reverse plate 15, while a resist film 16b is provided under the conductive patterns 13b. The entire surfaces of the reverse plates 15 and resist films 16a are laminated with a resin sheet 17 made of PET.

When the coordinate input unit 5 is pressed with a finger from above an input button 8, the coordinate input unit 5 and the surfacing sheet 7 are elastically deformed. The pressing force produced by this operation causes the corresponding reverse plate 15 to be pressed, reversed, and brought into contact with the corresponding circular electrode 13a1. This allows continuity between the electrodes 13a1 and 13a2 and the corresponding conductive pattern 13b and changes the switching output to the ON state. When the reverse plate 15 is reversed, the pressing reaction force provides the operator with a tactile feedback from the operation.

The input device 4 may be a liquid crystal tablet or the like, and the operating member may be a pen or the like instead of a finger.

As illustrated in FIG. 8, the coordinate input unit 5 and the switching unit 6 are connected to a controller 20. Coordinate signals from the coordinate input unit 5 are converted by a coordinate data converter 25 to coordinate data (XY information), which is then input to the controller 20. Switching signals (ON information) from the switching unit 6 are also input to the controller 20.

The controller 20 includes a computing unit 21, a character readout unit 22, a character switching unit 23, and a mode switching unit 24.

On the basis of coordinate data received from the coordinate data converter 25, the computing unit 21 identifies which input button 8 is touched with a finger or determines the amount of movement of a finger.

On the basis of the computed information from the computing unit 21, the character readout unit 22, retrieves from a memory unit 26 a character to be displayed on the display device 3 and sends the corresponding character information to a display generating unit 27.

In response to a command from the mode switching unit 24, the character switching unit 23 sends to the character readout unit 22 information as to which type of character, that is, which of hiragana, katakana, number, alphabet, and the like is selected (NOTE: Katakana characters and hiragana characters represent the same sounds in the Japanese writing system. A difference is that katakana characters are typically used for words borrowed from other languages).

The mode switching unit 24 serves as a control means and is used for switching between various communication modes, including phone mode, email mode, and Web mode or is used, for example, for changing the type of character (such as hiragana and number) to be entered in email mode.

Upon receipt of signals from the character readout unit 22 and the mode switching unit 24, the display generating unit 27 generates a display processing signal for a screen to be displayed on the display device 3. Then, the display processing signal is sent to the display device 3 and displayed as characters and the like on the display device 3.

The input device 4 of the present embodiment includes the coordinate input unit 5, the switching unit 6, the coordinate data converter 25, the controller 20, the memory unit 26, and the display generating unit 27. However, this is just an example and the configuration of the input device 4 is not particularly limited to this. For example, it is possible that the input device 4 is composed only of the coordinate input unit 5, the switching unit 6, and the coordinate data converter 25, or composed only of the coordinate input unit 5, the switching unit 6, the coordinate data converter 25, and the controller 20.

A series of operations involved in entering characters will now be described. In the present specification, the term “character” refers to all types of characters that can be typed and displayed on the display device 3. Examples of such characters include “hiragana characters”, “katakana characters”, “numerical characters (numbers)”, “alphabetical characters”, and “symbols”.

First, the operator presses one of the input buttons 8 on the control panel 7a or another input button (not shown in FIG. 1) to start email mode.

The memory unit 26 stores hiragana characters in the “a”-column (the first column in the Japanese syllabary), katakana characters in the “a′”-column (the first column in the Japanese syllabary), the number “1”, and the symbols “.” and “@” in correspondence with an input button 8a marked “a” (character to the right of “1”), “1”, and “. @” as in FIG. 1. Therefore, operating the input button 8a allows these characters to be entered. Likewise, the memory unit 26 stores hiragana characters in the “ka”-column (the second column in the Japanese syllabary), katakana characters in the “ka′”-column (the second column in the Japanese syllabary), the number “2”, and the alphabetic characters “A”, “B” and “C” in correspondence with an input button 8b marked “ka” (character to the right of “2”), “2”, and “ABC”. Therefore, operating the input button 8b allows these characters to be entered. The same applies to the other input buttons 8.

When “hiragana input mode” is enabled by the character switching unit 23, the hiragana characters in the “a”-column (first column) can be entered by operating the input button 8a. It is predetermined that the hiragana characters are read according to the Japanese syllabary.

When the operator wishes to enter the hiragana character “e” (the fourth character in the “a”-column), the operator first touches with a finger F the input button 8a marked “a” (character to the right of “1”) (see FIG. 4A). Referring to FIG. 7, in step ST1, touching the input button 8a with the finger F causes coordinate data to be sent from the coordinate input unit 5 via the coordinate data converter 25 to the computing unit 21. On the basis of the received coordinate data, the computing unit 21 identifies the input button 8a touched by the finger F. In step ST2, the character readout unit 22 reads the first hiragana character “a” in the “a”-column (first column) in the Japanese syllabary from the memory unit 26 and sends the read data to the display generating unit 27. Then, the hiragana character “a” is displayed on the display device 3 (see FIG. 3B).

On the basis of the coordinate data from the coordinate input unit 5, the controller 20 continuously determines whether the finger F has been released from the input button 8a (step ST3). If the finger F has been released, the character currently displayed on the display device 3 is confirmed (step ST6). If the controller 20 determines that the finger F has not yet been released from the input button 8a, it is determined, on the basis of the coordinate data from the coordinate input unit 5, whether the finger F is tracing the outline of the input button 8a (step ST4).

The operator traces the outline of the input button 8a with the finger F as indicated by an arrow in FIG. 4A. If the controller 20 determines that the operator has completed tracing the entire outline of the input button 8a once, the character readout unit 22 reads the hiragana character “i”, which is subsequent to the hiragana character “a” in the Japanese syllabary, from the memory unit 26, sends the read data to the display generating unit 27, thereby allowing the hiragana character “i” to be displayed on the display device 3. Every time the finger F traces the entire outline of the input button 8a, characters are read one by one from the memory unit 26 in the order of the Japanese syllabary. Tracing the outline of the input button 8a three times with the finger F allows the hiragana character “e” (the fourth character in the “a”-column) to be displayed on the display device 3 (see FIG. 4B and step ST5 in FIG. 7).

Then, when the operator has released the finger F from the input button 8a, the controller 20 recognizes in step ST3 that the finger F has been released from the input button 8a, on the basis of the coordinate data from the coordinate input unit 5, and the hiragana character “e” currently displayed on the display device 3 is confirmed (step ST6).

In step ST7 in FIG. 7, the operator determines whether the confirmed character is correct. In other words, the operator determines whether the confirmed character is the one the operator wishes to enter. If the confirmed character is correct, the operator does nothing. On the other hand, if the confirmed character is not correct, the operator presses an input button 8c marked “CLEAR” shown in FIG. 1. This causes ON information from the switching unit 6 (shown in FIG. 8) to be sent to the controller 20, which then sends a signal for canceling the character display to the display generating unit 27. The character displayed on the display device 3 is thus deleted. The displayed character can be deleted by methods other than pressing the specific input button 8c. For example, it is possible that the character displayed on the display device 3 is deleted by tracing the outline of the input button 8a in the direction opposite that shown in FIG. 4A.

It can be configured such that tracing the outline of the input button 8a in the direction opposite that shown in FIG. 4A allows the hiragana characters to be read in the reverse order of the Japanese syllabary, such as “e”→“u”→“i”→“a” (the fourth, third, second, and first characters in the “a”-column). In this case, for example, even if the operator traces the outline of the input button 8a an excessive number of times and the hiragana character “e” (the fourth character in the “a”-column) instead of the desired hiragana character “u” (the third character in the “a”-column) is displayed on the display device 3, tracing the outline of the input button 8a in the direction opposite that shown in FIG. 4A allows the hiragana character “u” to be immediately displayed on the display device 3. Quicker entry of characters than before can thus be achieved.

In the present embodiment, a plurality of characters having a predetermined readout sequence are stored in correspondence with each input button 8. When the finger F comes into contact with the surface of an input button 8 to which a desired character is assigned, the first character in the predetermined readout sequence is initially read (first readout means) and displayed on the display device 3.

Then, sliding the finger F along the outline of the input button 8 allows characters assigned to the input button 8 to be read and displayed one by one on the display device 3 according to the readout sequence. The entry of the desired character can be confirmed by releasing the finger F from the input button 8 when the desired character appears on the display device 3.

As described above, the present embodiment eliminates the need for pressing a specific input button many times for entering a character, and allows a desired character to be entered by a simple operation, such as tracing the outline of the input button. Even if very long text has to be created in email mode, characters can be entered by a simpler and easier operation with less fatigue on fingers, compared to known methods in which characters are entered by pressing each input button many times.

Katakana characters can be entered if “Katakana input mode” is selected in the mode switching unit 24. Alternatively, a readout sequence can be defined, for example, as hiragana characters, katakana characters, numbers, alphabetic characters, and symbols in a manner such that all characters in the readout sequence can be read without changing the input mode in the mode switching unit 24. For example, a readout sequence for the input button 8a marked “a” (hiragana character to the right of “1”) is defined as follows: “a”, “i”, “u”, “e”, “o” (hiragana characters), “a”, “i′”, “u′”, “e′”, “o′” (katakana characters), “1”, . . . , and “@”. In this case, hiragana characters, katakana characters, numbers, alphabetic characters, and symbols can be entered without changing the input mode.

An embodiment illustrated in FIG. 5 is an alternative of that illustrated in FIG. 4A. In FIG. 5, the finger F passes over the surface of the input button 8a in the vertical direction in the drawing (in the direction indicated by an arrow). This allows characters to be read according to the readout sequence. If the character changes according to the readout sequence every time the finger F moves in the arrow direction (from downward to upward in the drawing), and if the operator counts the number of times the finger F has moved in the arrow direction in FIG. 5, the operator can accurately determine what character is currently being displayed on the display device 3 without actually looking at the screen of the display device 3, and can thus quickly enter characters. Moreover, compared to the method illustrated in FIG. 4A, it is easier to count the number of times the finger F has moved in the arrow direction. In the embodiment illustrated in FIG. 5, it can be controlled such that when the finger F moves in the direction opposite the arrow direction, characters are sequentially read in the reverse order of the Japanese syllabary, or the character currently being displayed on the display device 3 is deleted. Alternatively, it can be controlled such that characters are read according to the readout sequence when the finger F moves in the horizontal direction orthogonal to the arrow direction in FIG. 5.

In FIG. 5, if it is configured such that the character changes according to the readout sequence every time the finger F moves in the arrow direction, the finger F is momentarily released from the surface of the input button 8a during the interval between two movements in the arrow direction. Therefore, step ST3 in FIG. 7 is skipped in the embodiment in FIG. 5. In this case, the entry of a character is confirmed, for example, by pressing the input button 8a again or a confirmation button (not shown) when a desired character is displayed on the display device 3. Alternatively, it can be configured such that the entry of a character is confirmed at the point when the finger F touches an input button 8 that is not the input button 8a.

An embodiment illustrated in FIG. 6 is an alternative of those illustrated in FIG. 4A and FIG. 5. In FIG. 6, the entire surface of the control panel 7a is used. Specifically, by sliding the finger F over the control panel 7a, characters are sequentially read according to the readout sequence. For example, characters are sequentially read according to the readout sequence by moving the finger F across the control panel 7a in the horizontal direction as indicated by an arrow B in FIG. 6, or by moving the finger F over the control panel 7a in an arc as indicated by an arrow C in FIG. 6.

In FIG. 6, when the finger F touches an input button 8 to which a plurality of characters including a desired character are assigned, the first character in the readout sequence is displayed on the display device 3 (first readout means). In response to the movement of the finger F in the direction indicated by the arrow B or C in FIG. 6, characters are sequentially read and displayed on the display device 3 according to the readout sequence (second readout means). The embodiment illustrated in FIG. 6 thus allows the effective use of the entire surface of the control panel 7a and enables the easy entry of characters.

In FIG. 6, if it is configured such that the character changes according to the readout sequence every time the finger F moves in the direction indicated by the arrow B or C, the finger F is momentarily released from the control panel 7a during the interval between two movements in the arrow direction. Therefore, step ST3 in FIG. 7 is skipped in the embodiment in FIG. 6. In this case, the entry of a character is confirmed, for example, by pressing one of the input buttons 8 shown in FIG. 1 or a confirmation button (not shown) when a desired character is displayed on the display device 3.

In FIG. 3A, the finger F touches the surface of an input button 8 corresponding to a desired character. However, it can also be configured such that if the finger F touches a point off the input button 8, an input button 8 closest to the contact point of the finger F is activated as the target button to be used for entering the desired character. For example, if the finger F touches the area between the input button 8a and the input button 8b in FIG. 1, the computing unit 21 compares the distance between the contact point of the finger F and the input button 8a with the distance between the contact point of the finger F and the input button 8b, thereby determining which of the input button 8a and the input button 8b is closer to the contact point of the finger F. If the input button 8a is closer to the contact point, the input button 8a is activated as the target button to be used for entering the desired character, and the hiragana character “a” is displayed on the display device 3.

In FIG. 3A, it can also be configured such that the first character in the readout sequence is read and displayed on the display device 3 by pressing an input button 8 with the finger F once.

There are other methods, as well as those illustrated in FIG. 4A, FIG. 5, and FIG. 6, in which the character changes according to the readout sequence. For example, in the embodiment illustrated in FIG. 4A, the character changes every time the finger F traces the outline of the input button 8a once. It can also be configured such that during the period in which the finger F traces the outline of the input button 8a once, the character changes in order, such as “a”=“i”→“u”→“e”→“o”→“ₐ”→“ᵢ”→“ᵤ”→“ₑ”→“ₒ”→“a” . . . , every time the finger F moves a predetermined distance (or a predetermined angle around the center of the input button 8a). The character may change in such a manner that all characters assigned to the input button 8a according to the readout sequence are displayed by moving the finger F around the input button 8a once or one and a half times, or by moving the finger F halfway around the input button 8a. It can also be configured such that tracing the outline of the input button 8a in the direction opposite that shown in FIG. 4A allows characters to be read in the reverse order of the readout sequence, such as “a”→“ₒ”→“ₑ”→“ᵤ”→“ᵢ”→ₐ”→“o”→“e”→“u”→“i”→“a”→ . . . .

In FIG. 5, the character may be changed from the hiragana character “a” to the hiragana character “i” by moving the finger F upward, and changed from the hiragana character “i” to the hiragana character “u” by moving the finger F downward. In other words, it can be configured such that the character is changed by moving the finger F up and down on the input button 8a.

The input device 4 of the present embodiment may be configured such that it is applicable not only to mobile phones but also to other electronic equipment, particularly to small electronic equipment.

The input device 4 of the present invention may either be integral with electronic equipment having the display device 3, as in the case of the mobile phone 1, or may be separate from the electronic equipment having the display device and used as a remote control or a controller for a gaming machine.

What is claimed is:

1. An input device including a control panel provided with a plurality of input buttons, wherein a plurality of characters having a predetermined readout sequence are stored in correspondence with each of the input buttons, and wherein using an operating member on the control panel allows a character to be entered, the input device comprising:
first readout means configured to allow the first character in the readout sequence to be read by performing a first operation on one of the input buttons;
second readout means configured to allow a read character to be changed according to the readout sequence by performing a second operation of sliding the operating member over the control panel; and
input means configured to allow the input of a desired character to be confirmed by performing a third operation when the desired character has been read.

2. The input device according to claim 1, wherein the first operation is to bring the operating member into contact with a surface of the input button.

3. The input device according to claim 1, wherein the second operation is to slide the operating member along the outline of the input button or to slide the operating member over a surface of the input button.

4. The input device according to claim 3, wherein a read character is changed according to the readout sequence by moving the operating member a predetermined distance at a time along the outline of the input button.

5. The input device according to claim 1, wherein the third operation is to release the operating member from the control panel or to press a specific input button.
